(19) United States
(12) Patent Application Publication
(10) Pub. No.: US 2021/0316786 A1
(43) Pub. Date: Oct. 14, 2021

(54) VEHICLE STEERING SYSTEM

(71) Applicant: TOYOTA JIDOSHA KABUSHIKI KAISHA, Toyota-shi (JP)

(72) Inventor: Daisuke NAKATA, Seto-shi (JP)

(73) Assignee: TOYOTA JIDOSHA KABUSHIKI KAISHA, Toyota-shi (JP)

(21) Appl. No.: 17/223,574

(22) Filed: Apr. 6, 2021

(30) Foreign Application Priority Data
Apr. 14, 2020 (JP) 2020-072535

(51) Int. Cl. B62D 15/02; B62D 6/00

(52) U.S. Cl. CPC B62D 15/02; B62D 6/002

(57) ABSTRACT

A steering system for a vehicle, including: a pair of wheel steering devices that respectively steer right and left wheels independently of each other; and a controller configured to control the pair of wheel steering devices, wherein the controller is configured to change, based on a running speed of the vehicle, a steering amount ratio that is a ratio between a steering amount of the right wheel and a steering amount of the left wheel and to limit, based on a degree of change in the running speed of the vehicle, a change speed of the steering amount ratio at which the controller changes the steering amount ratio.

### CROSS REFERENCE TO RELATED APPLICATION

The present application claims priority to Japanese Patent Application No. 2020-072535, which was filed on Apr. 14, 2020, the disclosure of which is herein incorporated by reference in its entirety.

### BACKGROUND

### Technical Field

The following disclosure relates to a steering system installed on a vehicle for steering right and left wheels independently of each other.

### Description of Related Art

A steering system capable of steering right and left wheels independently of each other (hereinafter referred to as “right-left independent steering system” where appropriate) is known. As described in Patent Document 1 (Japanese Patent Application Publication No. 2019-171908), the steering system employs a technique of changing a ratio between a steering amount of the right wheel and a steering amount of the left wheel depending on a running speed of a vehicle (hereinafter referred to as “vehicle speed” where appropriate). The ratio between the steering amounts of the right and left wheels will be hereinafter referred to as “steering amount ratio” where appropriate. When the vehicle speed is high, the right and left wheels are steered according to the parallel geometry in which the steering amounts of the right and left wheels are equal. When the vehicle speed is low, the right and left wheels are steered according to the Ackermann geometry in which the steering amount of one of the right and left wheels located more distant from a center of turning of the vehicle, i.e., a turning outer wheel, is smaller than the steering amount of the other of the right and left wheels located closer to the center of turning of the vehicle, i.e., a turning inner wheel. Thus, the steering system enables the vehicle to enjoy turning stability and maneuverability with a small turning radius with good balance.

### SUMMARY

In the steering system configured to change the steering amount ratio of the right and left wheels depending on the vehicle speed, the steering amount ratio may largely change in a case where a degree of acceleration during accelerating of the vehicle or a degree of deceleration during decelerating of the vehicle is large. In this instance, it is expected that the driver may feel unnatural due to a change in the behavior of the vehicle. The utility of the right-left independent steering system can be improved by making some modification. Accordingly, an aspect of the present disclosure is directed to a vehicle steering system having high utility.

In one aspect of the present disclosure, the vehicle steering system includes: a pair of wheel steering devices that respectively steer right and left wheels independently of each other; and a controller configured to control the pair of wheel steering devices, wherein the controller is configured to change, based on a running speed of the vehicle, a steering amount ratio that is a ratio between a steering amount of the right wheel and a steering amount of the left wheel and to limit, based on a degree of change in the running speed of the vehicle, a change speed of the steering amount ratio at which the controller changes the steering amount ratio.

In the vehicle steering system (hereinafter simply referred to as “steering system” where appropriate) according to the present disclosure, the change speed of the steering amount ratio is limited based on the degree of change in the vehicle speed, thus preventing a driver from feeling unnatural due to a change in the behavior of the vehicle. Consequently, the steering system of the present disclosure has high utility.

### VARIOUS FORMS

The “steering amount” of each wheel may be regarded as an amount of an angular change from a position of the wheel in straight running of the vehicle to a steered position of the wheel, i.e., a steering angle. In this sense, the “steering mount ratio” of the right and left wheels may be regarded as a steering angle ratio. A large steering amount ratio means a large difference between the steering amount of the right wheel and the steering amount of the left wheel, and a small steering amount ratio means a small difference therebetween. To “change the steering amount ratio based on the vehicle speed” may be executed such that a difference between the steering amount of the right wheel and the steering amount of the left wheel decreases with an increase in the vehicle speed, for example. Specifically, the steering amount ratio may be a ratio according to the Ackermann ratio that will be later explained in detail. Moreover, the steering amount ratio may be set such that the steering amount of a turning outer wheel that is one of the right and left wheels located more distant from a center of turning of the vehicle is not larger than the steering amount of a turning inner wheel that is another one of the right and left wheels located closer to the center of the turning of the vehicle.

Concretely, the steering system of the present disclosure may be configured to determine the steering amount of one of the right and left wheels based on a steering request and determine the steering amount of the other of the right and left wheels based on i) the determined steering amount of the one of the right and left wheels and ii) the steering amount ratio set based on the running speed of the vehicle. In this configuration, the change speed of the steering amount ratio may be limited such that a change in the steering amount of the other of the right and left wheels with respect to the steering amount of the one of the right and left wheels is limited based on the degree of change in the running speed of the vehicle.

The “degree of change in the running speed of the vehicle” may be regarded as a change in the vehicle speed per unit time, i.e., a rate of change in the vehicle speed. Examples of a parameter indicative of the degree of change in the vehicle speed include acceleration in a front-rear direction of the vehicle generated in the vehicle, i.e., longitudinal acceleration of the vehicle, and a braking/driving force applied to the vehicle. The longitudinal acceleration takes a positive value when the vehicle is accelerating. When the vehicle is decelerating, the longitudinal acceleration is deceleration and takes a negative value. The braking/driving force is a concept that includes a driving force applied to the vehicle when the vehicle is accelerating and a braking force applied to the vehicle when the vehicle is decelerating. In the present disclosure, the change speed of the steering amount ratio may be limited based on those parameters.

In terms of an effect of preventing or reducing an unnatural feeling given to the driver, it is preferable to limit the change speed of the steering amount ratio to a greater extent when the degree of change in the running speed of the vehicle is high than when the degree of change in the running speed of the vehicle is low. Further, the steering amount ratio may be fixed when the degree of change in the running speed of the vehicle exceeds a set first degree and may be allowed to be changed subsequently when the degree of change in the running speed of the vehicle becomes lower than or equal to a second degree that is set so as to be lower than the first degree.

### BRIEF DESCRIPTION OF THE DRAWINGS

The objects, features, advantages, and technical and industrial significance of the present disclosure will be better understood by reading the following detailed description of embodiments, when considered in connection with the accompanying drawings, in which:

FIG. 1 is a schematic view illustrating an overall structure of a vehicle on which a steering system according to a first embodiment is installed;

FIG. 2 is a perspective view of a wheel mounting module in which is incorporated a wheel steering device of the steering system of the first embodiment;

FIG. 3A is a view schematically illustrating a steering state according to what is called parallel geometry;

FIG. 3B is a view schematically illustrating a steering state according to what is called Ackermann geometry;

FIG. 3C is a graph for explaining a steering amount ratio of right and left wheels;

FIG. 4 is a graph for explaining limitation on a change speed of the steering amount ratio of the right and left wheels in the steering system of the first embodiment;

FIG. 5 is a graph indicating a change in a steering amount of each wheel with respect to a vehicle speed in the steering system of the first embodiment;

FIG. 6 is a flowchart indicating a steering overall control program executed in the vehicle steering system of the first embodiment;

FIG. 7 is a flowchart indicating a wheel steering program executed in the steering system of the first embodiment;

FIG. 8 is a flowchart indicating a steering-angle-ratio determining subroutine executed in the steering overall control program in the steering system of the first embodiment;

FIG. 9 is a graph indicating a change in the steering amount of each wheel with respect to the vehicle speed in a steering system according to a second embodiment; and

FIG. 10 is a flowchart indicating a steering-angle-ratio determining subroutine executed in the steering overall control program in steering system of the second embodiment.

### DETAILED DESCRIPTION OF THE EMBODIMENTS

Referring to the drawings, there will be explained below in detail a vehicle steering system according to embodiments of the present disclosure. It is to be understood that the present disclosure is not limited to the details of the following embodiments but may be embodied based on the forms described in Various Forms and may be changed and modified based on the knowledge of those skilled in the art.

### First Embodiment

A. Overall Structure of Vehicle on which Steering System is Installed

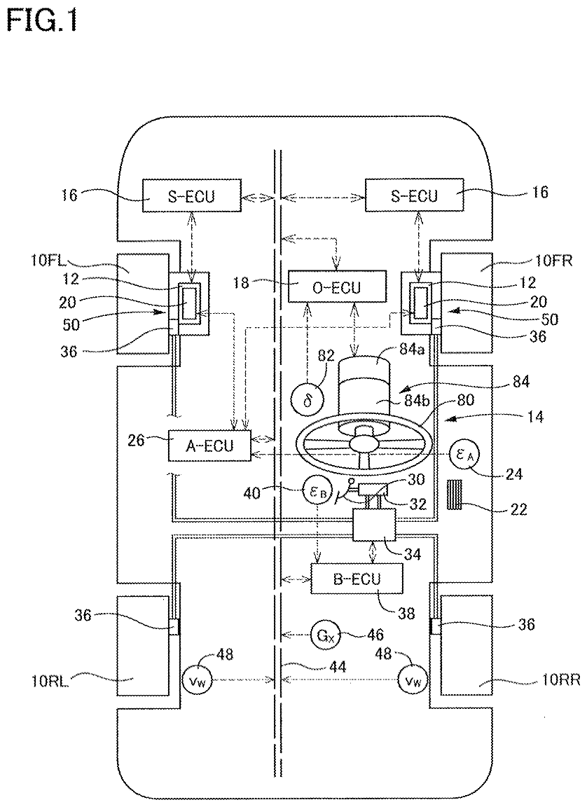

A steering system according to a first embodiment is installed on a vehicle having front left and right wheels 10FL, 10FR and rear left and right wheels 10RL, 10RR, as schematically illustrated in FIG. 1. The front left and right wheels 10FL, 10FR are drive wheels and streerable wheels. In the following description, when it is not necessary to distinguish the front left and right wheels 10FL, 10FR from each other, each of them will be referred to as the front wheel 10F. When it is not necessary to distinguish the rear left and right wheels 10RL, 10RR from each other, each of them will be referred to as the rear wheel 10R. When it is not necessary to distinguish the front wheel 10F and the rear wheel 10R from each other, each of them will be simply referred to as the wheel 10.

The present steering system is a steer-by-wire steering system and includes: a pair of wheel steering devices 12 provided for the respective front wheels 10F for steering the corresponding two front wheels 10F independently of each other; an operating device 14 for receiving an operation by a driver; a pair of steering electronic control units (hereinafter each abbreviated as “steering ECU” where appropriate) 16 for controlling the corresponding wheel steering devices 12; and an operating electronic control unit (hereinafter abbreviated as “operating ECU” where appropriate) 18 for controlling the operating device 14 and for performing overall control of the two steering ECUs 16. The configuration and the control of the present steering system will be later explained in detail. It may be understood that the two steering ECUs 16 and the operating ECU 18 constitute a controller of the present steering system.

A vehicle drive system is installed on the vehicle. The vehicle drive system includes a pair of wheel drive units 20 each provided for a corresponding one of the two front wheels 10F for drivingly rotating the corresponding front wheel 10F by an electric motor. The vehicle drive system includes: an accelerator pedal 22, as an accelerator operating pedal, operated by the driver; an accelerator operation amount sensor 24 for detecting an operation amount of the accelerator pedal 22; and a vehicle drive electronic control unit (hereinafter abbreviated as “drive ECU” where appropriate) 26 for controlling operations of the pair of wheel drive units 20 based on the accelerator operation amount detected by the accelerator operation amount sensor 24. The vehicle drive system has a known configuration and performs ordinary control, and an explanation thereof is dispensed with.

The vehicle further includes a hydraulic brake system. The brake system includes: a brake pedal 30, as a brake operating member, operated by the driver; a master cylinder 32 connected to the brake pedal 30; a working-fluid supply device 34 including a hydraulic pressure source such as a pump and configured to pressurize a working fluid; four brake devices 36 provided for the respective four wheels for braking the four wheels by a pressure of a working fluid supplied from the working-fluid supply device 34; and a brake electronic control unit (hereinafter abbreviated as “brake ECU” where appropriate) 38 for controlling the operation of the working-fluid supply device 34. The brake system is a brake-by-wire brake system. The brake ECU 38 controls the pressure of the working fluid supplied from the working-fluid supply device 34 to the brake device 36 of each wheel 10 based on a brake operation amount that is an operation amount of the brake pedal 30 detected by the brake operation amount sensor 40, so as to control the braking force applied to the vehicle. The brake system has a known configuration and performs ordinary control, and an explanation thereof is dispensed with.

The vehicle is equipped with a CAN (car area network or controllable area network) 44 to which the two steering ECUs 16, the operating ECU 18, the drive ECU 26, and the brake ECU 38 are connected. Those ECUs 16, 18, 26, 38 perform respective controls while communicating with one another via the CAN 44. In this respect, each of those ECUs 16, 18, 26, 38 includes a computer including a CPU, a ROM, a RAM, etc., and drivers (drive circuits) for driving corresponding constituent elements (such as an electric motor, a valve, and a pump) based on a command of the computer. The vehicle is provided with: a longitudinal acceleration sensor 46 for detecting longitudinal acceleration that is acceleration in the front-rear direction generated in the vehicle; and wheel speed sensors 48 provided for the respective two rear wheels 10R each for detecting a wheel rotation speed (hereinafter referred to as “wheel speed” where appropriate) v_{W} of the corresponding rear wheel 10R. The longitudinal acceleration sensor 46 and the wheel speed sensors 48 are also connected to the CAN 44.

### B. Hardware Configuration of Vehicle Steering System

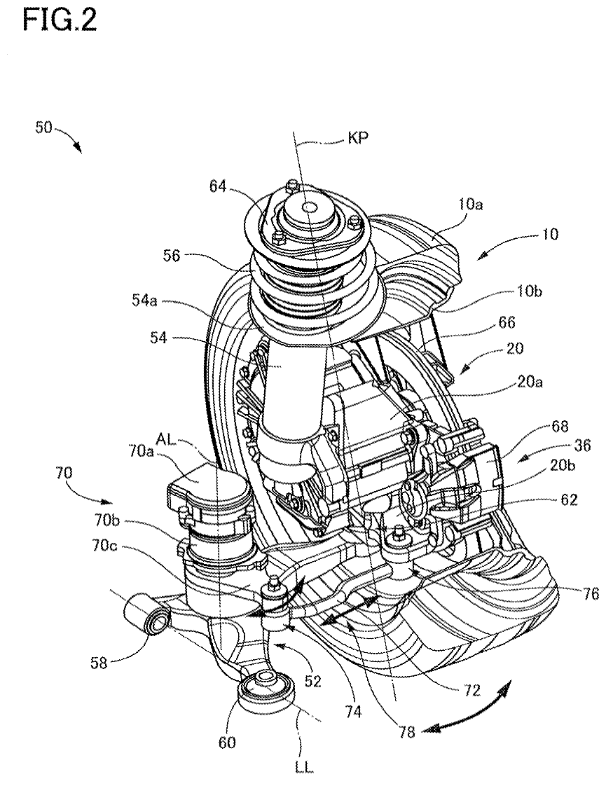

The two wheel steering devices 12 of the vehicle steering system according to the present embodiment are incorporated into respective two wheel mounting modules 50. Into each of the two wheel mounting modules 50, a corresponding one of the two wheel drive units 20 of the vehicle drive system and a corresponding one of the four brake devices 36 of the brake system are also incorporated. As illustrated in FIG. 2, the wheel mounting module (hereinafter simply referred to as “module” where appropriate) 50 is for mounting, on a body of the vehicle, a wheel 10b to which a tire 10a is attached. Though the wheel 10b itself may be regarded as the wheel, the wheel 10b to which the tire 10a is attached is referred to as the wheel 10 in the present embodiment for convenience sake.

The configuration of the wheel steering device 12 of the present steering system and the configuration of the module 50 will be explained. The wheel drive unit 20 incorporated in the module 50 includes: a housing 20a; an electric motor as a drive source and a speed reducer configured to reduce rotation of the electric motor (both the electric motor and the speed reducer are housed in the housing 20a and are not illustrated in FIG. 2); and an axle hub to which the wheel 10b is attached. (The axle hub is hidden and invisible in FIG. 2.) The wheel drive unit 20 is what is called in-wheel motor unit disposed inside a rim of the wheel 10b. The wheel drive unit 20 has a well-known structure, and an explanation thereof is dispensed with.

The module 50 includes a MacPherson-type suspension device (also referred to as a MacPherson strut type suspension device). In the suspension device, the housing 20a of the wheel drive unit 20 functions as a carrier that rotatably holds the wheel. Further, the housing 20a functions also as a steering knuckle in the wheel steering device 12 and is allowed to move upward and downward relative to the vehicle body. The suspension device is constituted by a lower arm 52 as a suspension arm, the housing 20a of the wheel drive unit 20, a shock absorber 54, and a suspension spring 56.

The suspension device has an ordinary structure and will be briefly explained. The lower arm 52 is an L-shaped arm. A proximal end portion of the lower arm 52 is divided into two portions in the front-rear direction of the vehicle. The lower arm 52 is supported at the proximal end portion thereof by a side member (not illustrated) of the vehicle body through a first bushing 58 and a second bushing 60 so as to be pivotable about an arm pivot axis LL. The housing 20a of the wheel drive unit 20 is pivotaly coupled at a lower portion thereof to a distal end portion of the lower arm 52 through a ball joint 62, as a first joint, for use in coupling the lower arm 52. The ball joint 62 will be hereinafter referred to as “first joint 62” where appropriate.

The shock absorber 54 is fixedly supported at a lower end thereof to the housing 20a of the wheel drive unit 20 and is supported at an upper end thereof by an upper portion of a tire housing of the vehicle body through an upper support 64. The suspension spring 56 is supported at an upper end thereof by the upper portion of the tire housing of the vehicle body through the upper support 64 and is supported at a lower end thereof by a lower support 54a in the form of a flange provided on the shock absorber 54. That is, the suspension spring 56 and the shock absorber 54 are disposed in parallel between the lower arm 52 and the vehicle body.

As described above, the module 50 includes the brake device 36. The brake device 36 is a disc brake device including: a disc rotor 66 attached to the axle hub together with the wheel 10b and configured to rotate with the wheel 10; and a brake caliper 68 held by the housing 20a of the wheel drive unit 20 such that the brake caliper 68 straddles the disc rotor 66. Though not explained in detail, the brake caliper 68 includes brake pads each as a friction member and a hydraulic cylinder. The brake device 36 is configured to generate a braking force for stopping rotation of the wheel 10 by pushing the brake pads against the disc rotor 66 in dependence on the pressure of the working fluid supplied from the working-fluid supply device 34 to the hydraulic cylinder.

The wheel steering device 12 is a single-wheel independent steering device for steering only one of the right and left wheels 10 independently of the other of the right and left wheels 10. The wheel steering device 12 includes the housing 20a of the wheel drive unit 20 functioning as the steering knuckle, a steering actuator 70 provided on the lower arm 52 at a position close to a proximal end portion of the lower arm 52, and a tie rod 72 coupling the steering actuator 70 and the steering knuckle 20a. The housing 20a of the wheel drive unit 20 will be referred to as “steering knuckle 20a” when treated as a constituent element of the wheel steering device 12.

The steering actuator 70 includes a steering motor 70a that is an electric motor as a drive source, a speed reducer 70b for decelerating rotation of the steering motor 70a, and an actuator arm 70c functioning as a pitman arm and configured to be pivoted by the rotation of the steering motor 70a decelerated by the speed reducer 70b. A proximal end portion of the tie rod 72 is coupled to the actuator arm 70c through a ball joint 74, as a second joint, for use in coupling the proximal end portion of the tie rod 72. (The ball joint 74 will be hereinafter referred to as “second joint 74” where appropriate.) A distal end portion of the tie rod 72 is coupled to a knuckle arm 20b of the steering knuckle 20a through a ball joint 76, as a third joint, for use in coupling the distal end portion of the tie rod 72. (The ball joint 76 will be hereinafter referred to as “third joint 76” where appropriate.)

In the wheel steering device 12, a line connecting the center of the upper support 64 and the center of the first joint 62 is the kingpin axis KP. By the motion of the steering motor 70a, the actuator arm 70c of the steering actuator 70 pivots about an actuator axis AL as indicated by a bold arrow in FIG. 2, and the pivotal movement of the actuator arm 70c is transmitted to the steering knuckle 20a by the tie rod 72, so that the steering knuckle 20a is rotated about the kingpin axis KP. That is, the wheel 10 is steered as indicated by a bold arrow in FIG. 2. Thus, the wheel steering device 12 includes a motion converting mechanism 78 constituted by the actuator arm 70c, the tie rod 72, the knuckle arm 20b, etc., for converting the rotating motion of the steering motor 70a into the steering motion of the wheel 10.

In the wheel steering device 12, the steering actuator 70 is disposed on the lower arm 52. Thus, a work of mounting the module 50 on the vehicle body can be easily performed. That is, the proximal end portion of the lower arm 52 is attached to the side member of the vehicle body, and the upper support 64 is attached to the upper portion of the tire housing of the vehicle body, whereby the suspension device, the brake device, and the wheel steering device can be mounted on the vehicle. In other words, the module 50 is excellent in mountability on the vehicle.

The operating device 14 has a configuration known in the steer-by-wire steering system. As illustrated in FIG. 1, the operating device 14 includes: a steering wheel 80, as a steering operating member, operated by the driver; a steering sensor 82 for detecting a steering operation angle that is a rotation angle of the steering wheel 80 as an operation amount of the steering operating member from a position thereof in straight running of the vehicle; and a reaction-force applying device 84 configured to apply an operation reaction force to the steering wheel 80. The reaction-force applying device 84 includes a reaction force motor 84a that is an electric motor as a source of the reaction force and a speed reducer 84b for transmitting a force of the reaction force motor 84a to the steering wheel 80.

### C. Control of Vehicle Steering System

i) Basic Control

In the present steering system, the operating ECU 18 determines, as a target of the steering amount of each front wheel 10F, a target steering angle ψ_{L}* of the front left wheel 10FL and a target steering angle ψ_{R}* of the front right wheel 10FR. Based on the determined target steering angles ψ_{L}*, ψ_{R}*, the steering ECUs 16 control the corresponding wheel steering devices 12 to steer the front left wheel 10FL and the front right wheel 10FR such that steering angles ψ_{L}, ψ_{R} thereof become equal to the target steering angles ψ_{L}*, ψ_{R}*.

Specifically, the operating ECU 18 determines a target vehicle-body slip angle β_{S}* that is a vehicle-body slip angle β_{S} to be attained in the vehicle body, based on the steering request, namely, based on the steering operation angle δ obtained by the steering sensor 82. In this respect, in a case where the vehicle is performing automated driving, information on the target vehicle-body slip angle β_{S}* is sent as the steering request from an automated driving system (not illustrated) via the CAN 44. The operating ECU 18 determines, based on the target vehicle-body slip angle β_{S}*, which one of the front left and right wheels 10FL, 10FR is a turning outer wheel (that is more distant from a center of turning of the vehicle, i.e., a turning center) and which one of the front left and right wheels 10FL, 10FR is a turning inner wheel (that is nearer to the turning center). Hereinafter, the turning outer wheel and the turning inner wheel will be respectively referred to as “turning outer wheel 10FO” and “turning inner wheel 10FI” where appropriate.

As described above, the operating ECU 18 determines the target steering angles ψ_{L}*, ψ_{R}* that are targets of the steering angles ψ_{L}, ψ_{R} of the front left and right wheels 10FL, 10FR. In the present steering system, a ratio R between the steering angle ψ_{L} of the left wheel and the steering angle ψ_{R} of the right wheel (hereinafter referred to as “steering angle ratio” where appropriate) as a ratio between the steering amount of the left wheel and the steering amount of the right wheel (i.e., a steering amount ratio) is changed depending on a vehicle speed v. The operating ECU 18 determines the target steering angles ψ_{L}*, ψ_{R}* based on the steering angle ratio R set in advance based on the vehicle speed v.

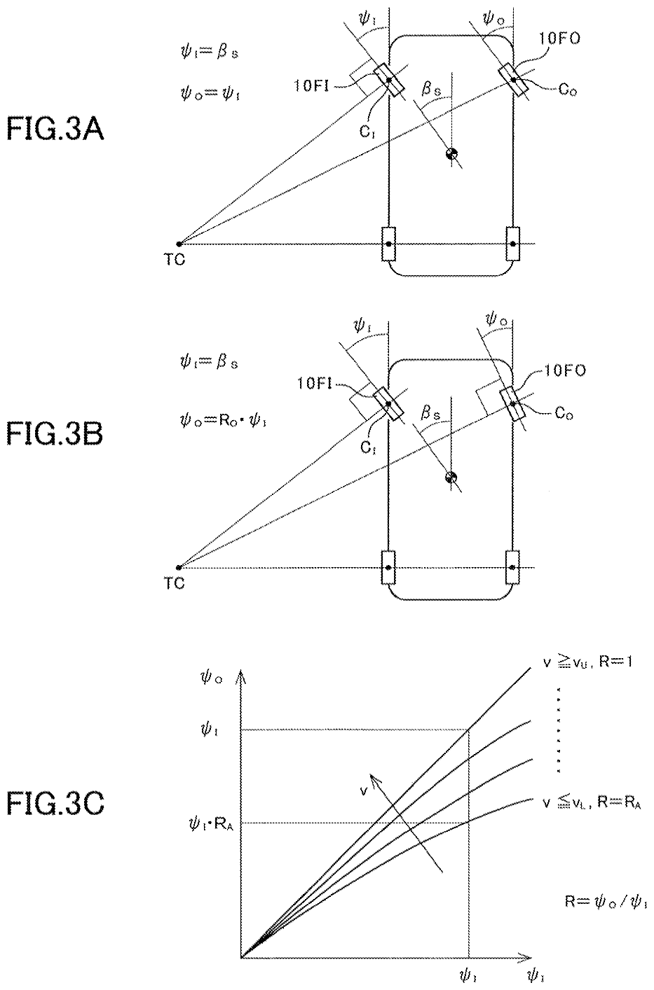

Referring to FIG. 3, the steering angle ratio R will be explained in detail. When the steering angle of the turning outer wheel 10FO is defined as ψ_{O} and the steering angle of the turning inner wheel 10FI is defined as ψ_{I}, the steering angle ratio R is represented as R=ψ_{O}/ψ_{I}, for example.

FIG. 3A schematically illustrates a steering state according to what is called parallel geometry. In the steering state illustrated in FIG. 3A, the steering angle Wo of the turning outer wheel 10FO and the steering angle ψ_{I} of the turning inner wheel 10FI are equal to each other. Thus, the steering angle ratio R is “1”. The orientation (direction) of the turning inner wheel 10FI makes a right angle with respect to a line that connects a center TC of turning of the vehicle (hereinafter referred to as “turning center TC” where appropriate) and a center C_{I} of an area of the turning inner wheel 10FI contacting the ground. (Hereinafter, the area of each wheel contacting the ground will be referred to as “ground contact area” where appropriate.) In contrast, the orientation of the turning outer wheel 10FO does not make a right angle with respect to a line that connects the turning center TC and a center Co of a ground contact area of the turning outer wheel 10FO. In the present steering system, the steering angle ψ_{I} of the turning inner wheel 10FI is treated as being equal to the vehicle-body slip angle β_{S} for convenience sake.

FIG. 3B schematically illustrates a steering state according to what is called Ackermann geometry. In the steering state illustrated in FIG. 3B, the orientation of the turning inner wheel 10FI makes a right angle with respect to the line that connects the turning center TC and the center C_{I} of the ground contact area of the turning inner wheel 10FI, and the orientation of the turning outer wheel 10FO makes a right angle with respect to the line that connects the turning center TC and the center Co of the ground contact area of the turning outer wheel 10FO. Accordingly, the steering angle ψ_{O} of the turning outer wheel 10FO is smaller than the steering angle ψ_{I} of the turning inner wheel 10FI. The steering angle ratio R in the steering state of FIG. 3B is equal to an Ackermann steering-angle ratio R_{A} that is a specific value.

The Ackermann ratio A is equal to 0% in the steering state according to the parallel geometry and is equal to 100% in the steering state according to the Ackermann geometry. The relationship between the Ackermann ratio A and the steering angle ratio R is represented by the following expression:

A=(1−R)/(1−R_{A})×100%

In a case where the Ackermann ratio A is high, slipping of the tire 10a during turning of the vehicle is prevented or reduced, thus reducing or preventing wear of the tire 10a and squealing noise generated by the tire 10a. On the other hand, in a case where the Ackermann ratio A is low, turning performance of the vehicle is enhanced, thus making running of the vehicle zippy or sporty. In view of these facts, the operating ECU 18 in the present steering system changes the steering angle ratio R depending on the vehicle speed v for changing the Ackermann ratio A.

FIG. 3C is a graph illustrating a relationship between the vehicle speed v and the steering angle ratio R. As illustrated in the graph, the operating ECU 18 sets the steering angle ratio R such that a difference between the steering angle ψ_{I} of the turning inner wheel 10FI and the steering angle ψ_{O} of the turning outer wheel 10FO decreases with an increase in the vehicle speed v. Conversely, the operating ECU 18 sets the steering angle ratio R such that the difference between the steering angle ψ_{I} of the turning inner wheel 10FI and the steering angle ψ_{O} of the turning outer wheel 10FO increases with a decrease in the vehicle speed v. Specifically, in a case where the vehicle speed v is not higher than a lower-limit speed v_{L} (e.g., 20 km/h), the operating ECU 18 sets the steering angle ratio R to the Ackermann steering-angle ratio R_{A}. In a case where the vehicle speed v is not lower than an upper-limit speed v_{U} (e.g., 100 km/h), the operating ECU 18 sets the steering angle ratio R to 1. In a case where the vehicle speed v is intermediate between the lower-limit speed v_{L} and the upper-limit speed v_{U}, the operating ECU 18 sets the steering angle ratio R so as to get close to 1 from the Ackermann steering-angle ratio R_{A} with an increase in the vehicle speed v.

The operating ECU 18 determines, based on the target vehicle-body slip angle β_{S}*, a target inner-wheel steering angle ψ_{I}* that is a target steering angle ψ* of the turning inner wheel 10FI according to the following expression:

ψ_{I}*=β_{S}*

The operating ECU 18 identifies the steering angle ratio R based on the target inner-wheel steering angle ψ_{I}* and the vehicle speed v referring to map data illustrated in FIG. 3C. The operating ECU 18 then determines a target outer-wheel steering angle ψ_{O}* that is a target steering angle ψ_{O}* of the turning outer wheel 10FO according to the following expression, based on the identified steering angle ratio R and the target inner-wheel steering angle ψ_{I}* of the turning inner wheel 10FL

ψ_{O}*=ψ_{I}*×R

In this respect, the operating ECU 18 identifies the vehicle speed v based on i) wheel speeds v_{W} of the respective front wheels 10F each of which depends on a rotational speed of a drive motor of the corresponding wheel drive unit 20 and ii) wheel speeds v_{W} of the respective rear wheels 10R each of which depends on detection by the corresponding wheel speed sensor 48.

When the front left wheel 10FL is the turning outer wheel 10FO, the operating ECU 18 determines a left-wheel target steering angle ψ_{L}* (which is the target steering angle ψ* of the front left wheel 10FL) to be ψ_{O}* and determines a right-wheel target steering angle ψ_{R}* (which is the target steering angle ψ* of the front right wheel 10FR) to be equal to ψ_{I}*. When the front right wheel 10FR is the turning outer wheel 10FO, the operating ECU 18 determines the left-wheel target steering angle ψ_{L}* to be ψ_{I}* and determines the right-wheel target steering angle ψ_{R}* to be ψ_{O}*. The operating ECU 18 transmits information on the determined target steering angles ψ_{L}*, ψ_{R}* respectively to the two steering ECUs 16 corresponding to the respective front right and left wheels 10F via the CAN 44.

Each steering ECU 16 controls the corresponding wheel steering device 12 such that the steering angle ψ of the corresponding front wheel 10F becomes equal to the target steering angle ψ* transmitted thereto. Specifically, the wheel steering device 12 is not equipped with a steering angle sensor for directly detecting the steering angle ψ of the wheel 10. In the present steering system, therefore, the steering ECU 16 controls a steering force generated by the steering actuator 70 based on a rotation angle θ of the steering motor 70a (hereinafter referred to as “motor rotation angle”) utilizing a specific relationship between the steering angle ψ of the wheel 10 and the rotation angle θ of the steering motor 70a. The steering force generated by the steering actuator 70 is equivalent to a steering torque Tq generated by the steering motor 70a. Thus, the steering ECU 16 determines a target steering torque Tq* that is the steering torque Tq to be generated by the steering motor 70a, based on the motor rotation angle θ of the steering motor 70a. In this respect, the motor rotation angle θ is regarded as a displacement angle of a motor shaft from a state in which the vehicle is running straight. The motor rotation angle θ is accumulated over 360°.

The target steering torque Tq* is determined as follows. The steering ECU 16 determines, for the corresponding front wheel 10F, a target motor rotation angle θ* that is a target of the motor rotation angle θ, based on the target steering angle ψ*. The steering motor 70a is a brushless DC motor and includes a motor rotation angle sensor (such as a Hall IC or a resolver) for phase switching in supplying the electric current thereto. Based on the detection by the motor rotation angle sensor, the steering ECU 16 recognizes an actual motor rotation angle θ that is the motor rotation angle θ at the present time point with respect to a reference motor rotation angle. The steering ECU 16 obtains a motor rotation angle deviation Δθ that is a deviation of the actual motor rotation angle θ with respect to the target motor rotation angle θ*. Based on the motor rotation angle deviation Δθ(=θ*−θ), the steering ECU 16 determines the target steering torque Tq* according to the following expression:

Tq*=G_{P}·Δθ+G_{D}·(dΔθ/dt)+G_{I}·∫Δθdt

The above expression is an expression according to a feedback control law based on the motor rotation angle deviation Δθ. The first term, the second term, and the third term in the expression are a proportional term, a derivative term, and an integral term, respectively. Further, G_{P}, G_{D}, G_{I} represent a proportional gain, a derivative gain, and an integral gain, respectively.

The steering torque Tq and a supply current I to the steering motor 70a are in a specific relationship relative to each other. In other words, the steering torque Tq depends on the force generated by the steering motor 70a, and the steering torque Tq and the supply current I are generally proportional to each other. Accordingly, the steering ECU 16 determines, based on the determined the target steering torque Tq*, a target supply current I* that is a target of the supply current I to the steering motor 70a and supplies the target supply current I* to the steering motor 70a.

ii) Limitation on Changing of Steering Angle Ratio and State of Change in Steering Angle

According to the basic control explained above, the steering angle ratio R of the front right and left wheels 10F is changed depending on the vehicle speed v. For example, the vehicle speed v may largely change in braking or in accelerating of the vehicle. In a case where a rate of change in the vehicle speed v is high, a speed at which the steering angle ratio R is changed, i.e., a change speed of the steering angle ratio R, is high, and the steering angle ψ_{O} of the turning outer wheel 10FO changes relatively quickly. This change of the steering angle ψ_{O} causes an unintended change in a side force that acts on the vehicle, so that the vehicle behavior may be disturbed or the driver may suffer from an unnatural feeling. In view of this, the present steering system imposes a limitation on changing of the steering angle ratio R.

Here, the speed at which the steering angle ratio R is changed is defined as a steering-angle-ratio change speed ΔR. In the present steering system, the operating ECU 18 determines the steering angle ratio R such that the steering-angle-ratio change speed ΔR does not exceed a change-speed limit value ΔR_{LIM} and determines the target steering angle of the turning outer wheel 10FO based on the determined steering angle ratio R.

Specifically, the operating ECU 18 executes a steering overall control program at a predetermined time pitch as later explained and determines the steering angle ratio R every time the program is executed. As explained above, the operating ECU 18 determines the steering angle ratio R referring to the above-indicated map data based on the target inner-wheel steering angle ψ_{I}* and the vehicle speed v. This steering angle ratio R is a standard steering angle ratio R_{S} that is a temporal steering angle ratio. The operating ECU 18 identifies, as a previous steering angle ratio R_{PRE}, the steering angle ratio R finally determined in previous execution of the program. The operating ECU 18 then identifies a difference between the previous steering angle ratio R_{PRE} and the standard steering angle ratio R_{S} as an amount of change of the steering angle ratio R per the time pitch at which the program is executed, namely, as a steering-angle-ratio change speed ΔR. In a case where an absolute value of the steering-angle-ratio change speed ΔR is larger than the change-speed limit value ΔR_{LIM}, the operating ECU 18 imposes a limitation on the changing of the steering angle ratio R. Specifically, the operating ECU 18 limits the steering-angle-ratio change speed ΔR so as to be lower than or equal to the change-speed limit value ΔR_{LIM}.

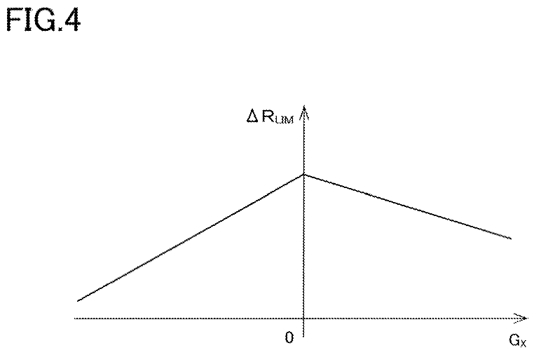

The operating ECU 18 of the present steering system determines the change-speed limit value ΔR_{LIM} referring to map data shown in a graph of FIG. 4 based on longitudinal acceleration Gx detected by the longitudinal acceleration sensor 46 provided in the vehicle. A positive value of the longitudinal acceleration Gx indicates that the vehicle is accelerating while a negative value of the longitudinal acceleration Gx indicates that the vehicle is decelerating. As apparent from the graph, the change-speed limit value ΔR_{LIM} is set so as to become smaller with an increase in an absolute value of the longitudinal acceleration Gx during both acceleration and deceleration of the vehicle. That is, with an increase in the degree of acceleration or deceleration, a greater limitation is imposed on the changing of the steering angle ratio R.

Specifically, in a case where the absolute value of the steering-angle-ratio change speed ΔR is not larger than the change-speed limit value ΔR_{LIM}, the operating ECU 18 maintains the steering-angle-ratio change speed ΔR. In a case where the absolute value of the steering-angle-ratio change speed ΔR is larger than the change-speed limit value ΔR_{LIM}, on the other hand, the operating ECU 18 replaces the steering-angle-ratio change speed ΔR with the change-speed limit value ΔR_{LIM} during acceleration while the operating ECU 18 replaces the steering-angle-ratio change speed ΔR with the change-speed limit value ΔR_{LIM} whose sign is inverted during deceleration. The operating ECU 18 adds the thus maintained or replaced steering-angle-ratio change speed ΔR to the previous steering angle ratio R_{PR}, to thereby determine the steering angle ratio R in current execution of the program.

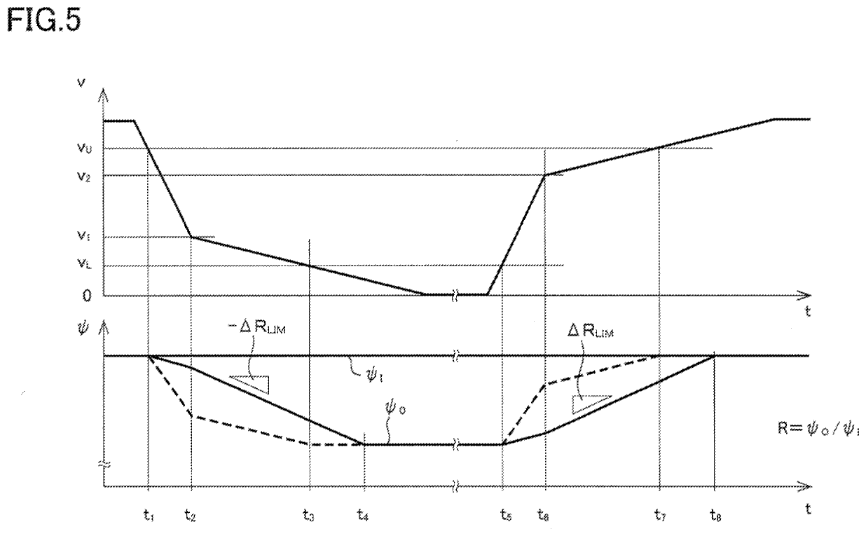

The graph of FIG. 5 indicates a change in the steering angle ψ_{O} of the turning outer wheel 10FO with respect to the vehicle speed v when the vehicle-body slip angle β_{S} is constant in a condition in which the steering-angle-ratio change speed ΔR is limited as described above. In a state in which the vehicle is decelerated at relatively large deceleration Gx by applying a relatively large braking force from the vehicle speed v higher than an upper-limit speed v_{U} to a first speed v₁ via an upper-limit speed v_{U}, the absolute value of the steering-angle-ratio change speed ΔR is relatively large and a change gradient of the steering angle ψ_{O} of the turning outer wheel 10FO is relatively large during a time period between a time t₁ to a time t₂ as indicated by the dashed line in a condition in which the steering-angle-ratio change speed ΔR is not limited. In contrast, in the condition in which the steering-angle-ratio change speed ΔR is limited, the absolute value of the steering-angle-ratio change speed ΔR is relatively small and the change in the steering angle ψ_{O} of the turning outer wheel 10FO, namely, the change in the steering angle ratio R, is relatively gentle during the time period between the time t₁ to the time t₂. Thereafter, in a time period from the time t₂ to a time when the vehicle stops in which the vehicle is decelerated at relatively small deceleration Gx and finally stops via a lower-limit speed v_{L}, the absolute value of the steering-angle-ratio change speed ΔR is relatively small and the steering angle ψ_{O} of the turning outer wheel 10FO, namely, the steering angle ratio R, changes relatively gently to a time when the vehicle speed v becomes equal to the lower-limit speed v_{L}, namely, to a time t₃, as indicated by the dashed line in the condition in which the steering-angle-ratio change speed ΔR is not limited. Also in the condition in which the steering-angle-ratio change speed ΔR is limited, the absolute value of the steering-angle-ratio change speed ΔR is relatively small and the steering angle ψ_{O} of the turning outer wheel 10FO, namely, the steering angle ratio R, changes relatively gently to a time t₄ that is later than the time t₃.

In a state in which the vehicle is accelerated at relatively large acceleration Gx by applying a relatively large driving force from the vehicle speed v lower than the lower-limit speed v_{L} to a second speed v₂ via the lower-limit speed v_{L}, the absolute value of the steering-angle-ratio change speed ΔR is relatively large and the change gradient of the steering angle ψ_{O} of the turning outer wheel 10FO is relatively large during a time period from a time t₅ to a time t₆ as indicated by the dashed line in the condition in which the steering-angle-ratio change speed ΔR is not limited. In contrast, in the condition in which the steering-angle-ratio change speed ΔR is limited, the absolute value of the steering-angle-ratio change speed ΔR is relatively small and the change in the steering angle ψ_{O} of the turning outer wheel 10FO, namely, the change in the steering angle ratio R, is relatively gentle during the time period from the time is to the time t₆. Thereafter, when the vehicle speed v increases from the time t₆ at relatively small acceleration Gx via the upper-limit speed v_{U}, the absolute value of the steering-angle-ratio change speed ΔR is relatively small and the steering angle ψ_{O} of the turning outer wheel 10FO, namely, the steering angle ratio R, changes relatively gently to a time when the vehicle speed v becomes equal to the upper-limit speed v_{U}, namely, to a time t₇, as indicated by the dashed line in the condition in which the steering-angle-ratio change speed ΔR is not limited. Also in the condition in which the steering-angle-ratio change speed ΔR is limited, the absolute value of the steering-angle-ratio change speed ΔR is relatively small and the steering angle ψ_{O} of the turning outer wheel 10FO changes relatively gently to a time t₅ that is later than the time t₇.

By limiting the steering-angle-ratio change speed ΔR based on the longitudinal acceleration Gx as explained above, the steering angle ratio R gently changes even when the vehicle speed v largely changes during deceleration or acceleration of the vehicle, thus effectively preventing the vehicle behavior from being disturbed and preventing an unnatural feeling from being given to the driver.

iii) Control Flow

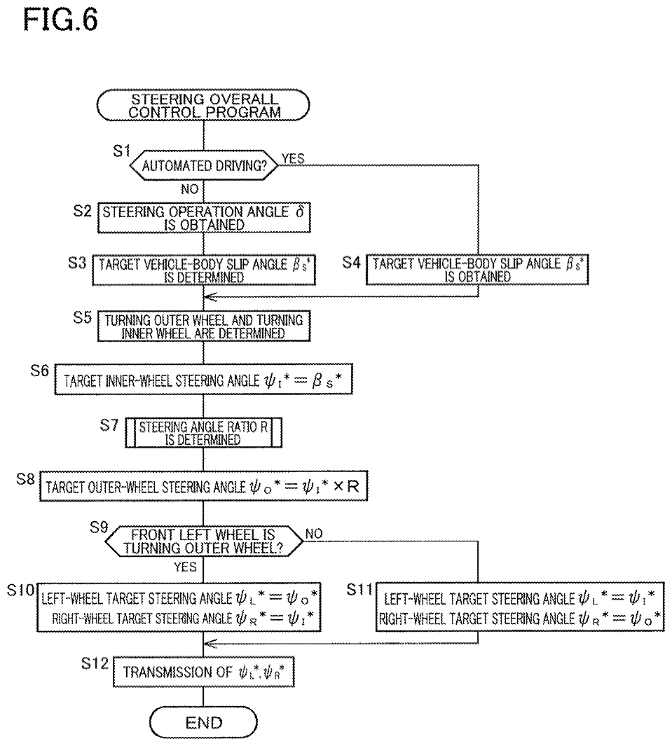

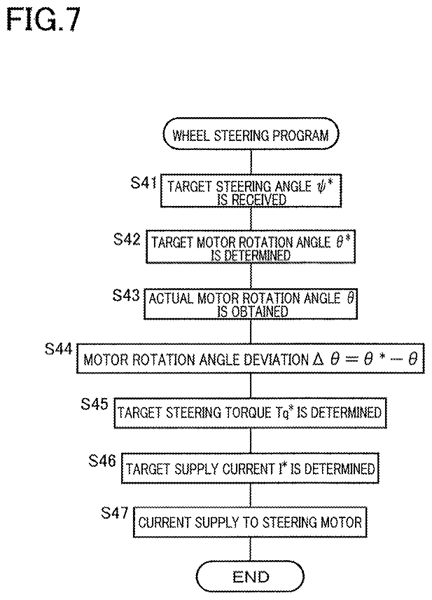

The computer of the operating ECU 18 repeatedly executes a steering overall control program indicated by a flowchart of FIG. 6 and the computer of each steering ECU 16 repeatedly executes a wheel steering program indicated by a flowchart of FIG. 7, at a short time pitch, e.g., from several to several tens of milliseconds (msec), whereby the control of the present steering system is executed. There will be hereinafter explained processes according to the flowcharts of the respective programs to briefly explain a flow of the control of the steering system.

In the process according to the steering overall control program, it is determined at Step 1 whether the automated driving is being performed. (Step 1 is abbreviated as “S1”, and other steps will be similarly abbreviated.). When the automated driving is not being performed, the steering operation angle δ is obtained at S2 based on detection by the steering sensor 82, and the target vehicle-body slip angle β_{S}* is determined at S3 based on the steering operation angle δ. When the automated driving is being performed, the target vehicle-body slip angle β_{S}* is obtained at S4 based on information from the automated driving system.

At S5, it is determined which one of the front left and right wheels 10FL, 10FR is the turning outer wheel 10FO and which one of the front left and right wheels 10FL, 10FR is the turning inner wheel 10FI, based on the target vehicle-body slip angle β_{S}*, specifically, based on the sign (+, −) thereof. At S6, the target inner-wheel steering angle ψ_{I}* is determined to be the target vehicle-body slip angle β_{S}*.

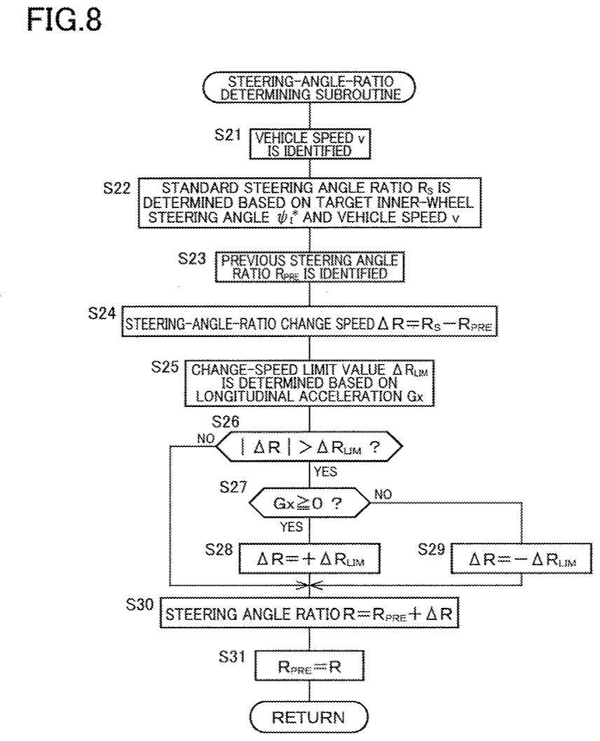

At S7, the steering-angle-ratio determining process for determining the steering angle ratio R is executed. The steering-angle-ratio determining process is executed by executing a steering-angle-ratio determining subroutine indicated by a flowchart of FIG. 8. In the process according to the subroutine, the vehicle speed v at the present time point is identified at S21 based on the wheel speeds v_{W} of the respective wheels 10. At S22, the standard steering angle ratio R_{S} is determined referring to the map data of FIG. 3C based on the vehicle speed v and the target inner-wheel steering angle ψ_{I}* determined as described above. At S23, the previous steering angle ratio R_{PRE}, which is the steering angle ratio R finally determined in previous execution of the program, is identified. At S24, by subtracting the previous steering angle ratio R_{PRE} from the determined standard steering angle ratio R_{S}, the amount of change of the steering angle ratio R per the time pitch at which the program is executed is determined, in other words, the steering-angle-ratio change speed ΔR is determined.

At S25, the change-speed limit value ΔR_{LIM} is determined referring to the map data of FIG. 4 based on the longitudinal acceleration Gx obtained by detection by the longitudinal acceleration sensor 46. At S26, it is determined whether the absolute value of the determined steering-angle-ratio change speed ΔR is larger than the change-speed limit value ΔR_{LIM}. When the absolute value of the steering-angle-ratio change speed ΔR is larger than the change-speed limit value ΔR_{LIM}, it is determined at S27 whether the sign of the longitudinal acceleration Gx is positive or negative. That is, it is determined whether the value of the longitudinal acceleration Gx indicates that the vehicle is accelerating. When the vehicle is accelerating (or the vehicle speed v is being maintained), the steering-angle-ratio change speed ΔR is limited to the change-speed limit value ΔR_{LIM} at S28. When the vehicle is decelerating, the steering-angle-ratio change speed ΔR is limited at S29 to the sign-inverted change-speed limit value ΔR_{LIM}, i.e., −ΔR_{LIM}. When it is determined at S26 that the absolute value of the steering-angle-ratio change speed ΔR is not larger than the change-speed limit value ΔR_{LIM}, the steering-angle-ratio change speed ΔR is maintained at the value determined at S24.

Based on the steering-angle-ratio change speed ΔR determined as described above, the steering-angle-ratio change speed ΔR is added to the previous steering angle ratio R_{PRE} at S30, so that the steering angle ratio R in current execution of the program is determined. At S31, the determined steering angle ratio R is set as the previous steering angle ratio R_{PRE} to be used in next execution of the program.

After completion of the process according to the subroutine, the target outer-wheel steering angle ψ_{O}* is determined at S8 based on the steering angle ratio R determined as described above in the process according to the subroutine. At S9, it is determined whether the front left wheel 10FL is the turning outer wheel. When the front left wheel 10FL is the turning outer wheel, the left-wheel target steering angle ψ_{L}* is made equal to the target outer-wheel steering angle ψ_{O}* and the right-wheel target steering angle ψ_{R}* is made equal to the target inner-wheel steering angle ψ_{I}*, at S10. When the front left wheel 10FL is not the turning outer wheel, the left-wheel target steering angle ψ_{L}* is made equal to the target inner-wheel steering angle ψ_{I}* and the right-wheel target steering angle ψ_{R}* is made equal to the target outer-wheel steering angle ψ_{O}*, at S11. At S12, information on the left-wheel target steering angle ψ_{L}* is transmitted to the steering ECU 16 of the front left wheel 10FL and information on the right-wheel target steering angle ψ_{R}* is transmitted to the steering ECU 16 of the front right wheel 10FR.

In the process according to the wheel steering program executed by each steering ECU 16, information on the target steering angle ψ* of the corresponding front wheel 10F is received from the operating ECU 18 at S41. At S42, the target motor rotation angle θ* of the steering motor 70a is determined based on the target steering angle ψ*. At S43, an actual motor rotation angle θ, which is an actual rotation angle of the steering motor 70a, is obtained. At S44, the motor rotation angle deviation Δθ, which is a deviation of the actual motor rotation angle θ with respect to the target motor rotation angle θ*, is determined. At S45, the target steering torque Tq* is determined based on the motor rotation angle deviation Δθ according to the above expression. At S46, the target supply current I*, which is an electric current to be supplied to the steering motor 70a, is determined based on the target steering torque Tq*. At S47, the electric current based on the target supply current I* is supplied to the steering motor 70a.

### Second Embodiment

A vehicle steering system according to a second embodiment is identical in hardware configuration to the vehicle steering system according to the first embodiment, and the control as to the steering of the front wheels 10F in the second embodiment differs from that of the first embodiment only in the limitation imposed on the changing of the steering angle ratio R. In view of this, the steering system according to the second embodiment will be explained only in terms of the limitation imposed on the changing of the steering angle ratio R.

In the steering system of the first embodiment, the operating ECU 18 determines the change-speed limit value ΔR_{LIM} based on the detected longitudinal acceleration Gx and limits the steering-angle-ratio change speed ΔR so as to be lower than or equal to the change-speed limit value ΔR_{LIM}, thereby imposing the limitation on the changing of the steering angle ratio R. In the steering system of the second embodiment, the operating ECU 18 estimates a braking force F_{B} and a driving force F_{D} (hereinafter referred to as “braking/driving force F” where appropriate) to be applied to the vehicle, based on a braking operation and an accelerating operation, specifically, based on the brake operation amount ε_{B} that is the operation amount of the brake pedal 30 and the accelerator operation amount ε_{A} that is the operation amount of the accelerator pedal 22. Based on the braking/driving force F, the operating ECU 18 imposes the limitation on the changing of the steering angle ratio R.

Specifically, the operating ECU 18 identifies that a degree of change in the vehicle speed v exceeds a first degree and fixes the value of the steering angle ratio R in a case where the estimated braking force F_{B} is larger than a first set braking force F_{B1} that is set as a relatively large value and in a case where the estimated driving force F_{D} is larger than a first set driving force F_{D1} that is set as a relatively large value. (Hereinafter, these cases are collectively referred to as “case where the braking/driving force F is larger than a first set braking/driving force F₁” where appropriate). Subsequently, in a case where the estimated braking force F_{B} becomes smaller than or equal to a second set braking force F_{B2} that is set as a value smaller than the first set braking force F_{B1} and in a case where the estimated driving force F_{D} becomes smaller than or equal to a second set driving force F_{D2} that is set as a value smaller than the first set driving force F_{D1} (hereinafter these cases will be referred to as “case where the braking/driving force F becomes smaller than or equal to the second set braking/driving force F₂” where appropriate), the operating ECU 18 identifies that the degree of change in the vehicle speed v becomes lower than or equal to a second degree that is set to be lower than the first degree and allows the steering angle ratio R to be changed at a speed lower than or equal to a fixed change-speed limit value ΔR_{LIM} (that is ±ΔR_{LIM} in a strict sense) as a set change speed. That is, the steering angle ratio R is made close to the standard steering angle ratio R_{S} relatively gently. In this respect, the change-speed limit value ΔR_{LIM} during acceleration of the vehicle and the change-speed limit value ΔR_{LIM} during deceleration of the vehicle may differ from each other.

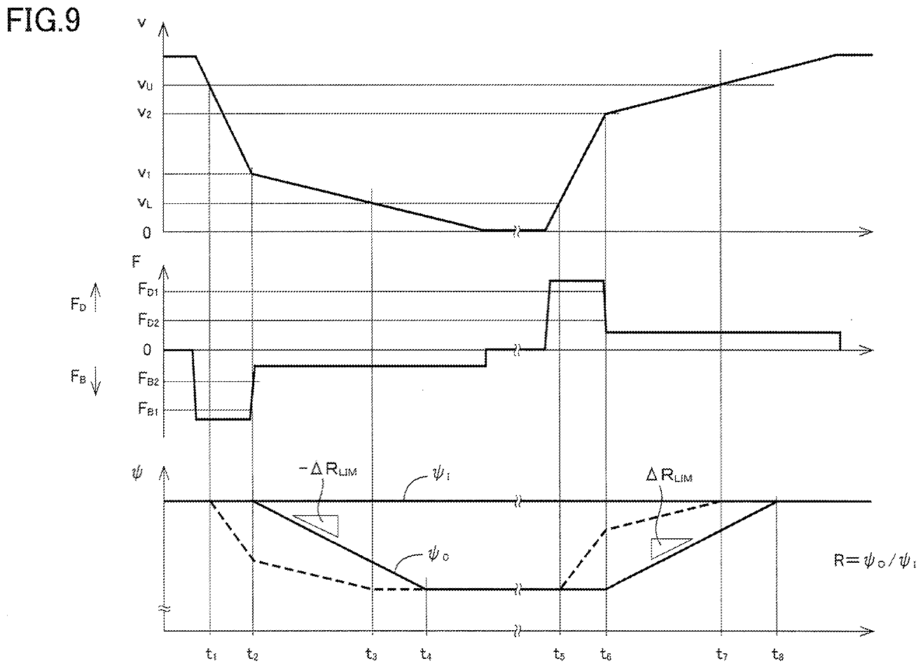

The graph of FIG. 9 indicates a change in the steering angle ψ_{O} of the turning outer wheel 10FO with respect to the change in the vehicle speed v when the vehicle-body slip angle β_{S} is constant in a condition in which steering-angle-ratio change speed ΔR is limited as described above. In a state in which the vehicle is decelerated, by a relatively large braking operation, namely, by applying a relatively large braking force to the vehicle, from the vehicle speed v higher than the upper-limit speed v_{U} to a speed v₁ via the upper-limit speed v_{U}, the absolute value of the steering-angle-ratio change speed ΔR is relatively large and the change gradient of the steering angle ψ_{O} of the turning outer wheel 10FO is relatively large during a time period between a time t₁ and a time t₂ as indicated by the dashed line in a condition in which steering-angle-ratio change speed ΔR is not limited. In contrast, in the condition in which the steering-angle-ratio change speed ΔR is limited as described above, because the braking force F_{B} being applied is larger than the first set braking force F_{B1}, the steering angle ratio R, namely, the steering angle ψ_{O} of the turning outer wheel 10FO, does not change during the time period between the time t₁ and the time t₂. Thereafter, in a time period from the time t₂ to a time when the vehicle stops in which the vehicle is decelerated from the speed v₁ and finally stops via the lower-limit speed v_{L} in a state in which the driver weakens the braking operation to reduce the braking force F_{B} to a value smaller than the second set braking force F_{B2}, the absolute value of the steering-angle-ratio change speed ΔR is relatively small and the steering angle ψ_{O} of the turning outer wheel 10FO, namely, the steering angle ratio R, changes relatively gently to a time when the vehicle speed v becomes equal to the lower-limit speed v_{L}, namely, to a time t₃ as indicated by the dashed line in the condition in which steering-angle-ratio change speed ΔR is not limited. Also in the condition in which steering-angle-ratio change speed ΔR is limited, the steering-angle-ratio change speed ΔR is relatively low, namely, is equal to the change-speed limit value −ΔR_{LIM}, and the steering angle ψ_{O} of the turning outer wheel 10FO, namely, the steering angle ratio R, changes relatively gently to a time t₄ that is later than the time t₃.

In a state in which the vehicle is accelerated, by a relatively large accelerating operation, namely, by applying a relatively large driving force, from the vehicle speed v lower than the lower-limit speed v_{L} to a speed v₂ via the lower-limit speed v_{L}, the steering-angle-ratio change speed ΔR is relatively high and the change gradient of the steering angle ψ_{O} of the turning outer wheel 10FO is relatively large during a time period from a time t₅ to a time t₆ as indicated by the dashed line in the condition in which steering-angle-ratio change speed ΔR is not limited. In contrast, in the condition in which the steering-angle-ratio change speed ΔR is limited, because the driving force F_{D} being applied is larger than the first set driving force F_{D1}, the steering angle ratio R, namely, the steering angle ψ_{O} of the turning outer wheel 10FO, does not change during the time period from the time t₅ to the time t₆. Thereafter, when the vehicle speed v increases from the time t₆ via the upper-limit speed v_{U} in a state in which the driver weakens the accelerating operation to reduce the driving force F_{D} to a value smaller than the second set driving force F_{D2}, the absolute value of the steering-angle-ratio change speed ΔR is relatively small and the steering angle ψ_{O} of the turning outer wheel 10FO, namely, the steering angle ratio R, changes relatively gentry to a time when the vehicle speed v becomes equal to the upper-limit speed v_{U}, namely, to a time t₇, as indicated by the dashed line in the condition in which steering-angle-ratio change speed ΔR is not limited. Also in the condition in which the steering-angle-ratio change speed ΔR is limited, the steering-angle-ratio change speed ΔR is relatively low, namely, is equal to ΔR_{LIM}, and the steering angle ψ_{O} of the turning outer wheel 10FO, namely, the steering angle ratio R, changes relatively gently to a time is that is later than the time t₇.

By limiting the steering-angle-ratio change speed ΔR based on the estimated braking/driving force F as explained above, the steering angle ratio R gently changes even when the vehicle speed v largely changes during deceleration or acceleration of the vehicle, thus effectively preventing the vehicle behavior from being disturbed and preventing an unnatural feeling from being given to the driver also in the steering system of the present embodiment.

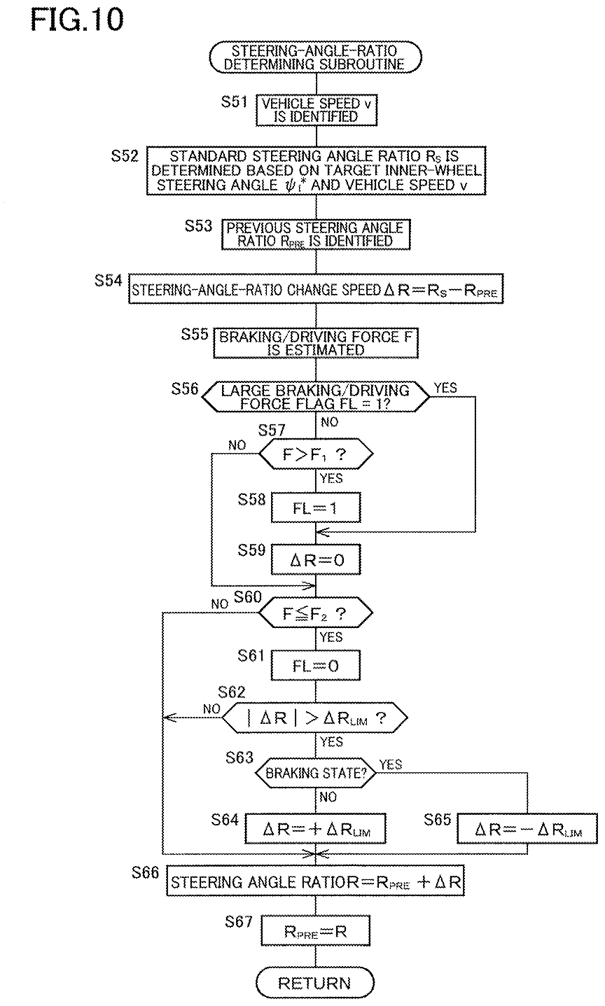

Also in the steering system of the second embodiment, the operating ECU 18 repeatedly executes the steering overall control program indicated by the flowchart of FIG. 6. However, the steering overall control program executed in the steering system of the second embodiment differs from the steering overall control program executed in the steering system of the first embodiment only in the steering-angle-ratio determining process of S7, i.e., the steering-angle-ratio determining subroutine. The steering-angle-ratio determining subroutine executed in the steering system of the second embodiment is indicated by a flowchart of FIG. 10. There will be hereinafter briefly explained a flow of the process referring to the flowchart.

In the process according to the steering-angle-ratio determining subroutine executed in the steering system of the second embodiment, the vehicle speed v at the present time point is identified at S51 based on the wheel speeds v_{W} of the respective wheels 10. At S52, the standard steering angle ratio R_{S} is determined referring to the map data of FIG. 3C based on the vehicle speed v and the target inner-wheel steering angle ψ_{I}* determined as described above. At S53, the previous steering angle ratio R_{PRE}, which is the steering angle ratio R finally determined in previous execution of the program, is identified. At S54, by subtracting the previous steering angle ratio R_{PRE} from the determined standard steering angle ratio R_{S}, the amount of change of the steering angle ratio R per the time pitch at which the program is executed is determined, in other words, the steering-angle-ratio change speed ΔR is determined.

At S55, the braking force F_{B} or the driving force F_{D} being applied to the vehicle, namely, the braking/driving force F, is estimated based on the brake operation amount ε_{B} detected by the brake operation amount sensor 40 or the accelerator operation amount ε_{A} detected by the accelerator operation amount sensor 24. At S56, it is determined whether a value of a large braking/driving force flag FL is “1”. The large braking/driving force flag FL, whose initial value is “0”, is set to “1” in a state in which a relatively large braking force F_{B} or a relatively large driving force F_{D} is being applied to the vehicle and the steering angle ratio R is fixed, namely, in a state in which the steering angle ratio R is prohibited from being changed.

When the large braking/driving force flag FL is not “1”, it is determined at S57 whether the braking/driving force F is larger than the first set braking/driving force F₁. When the braking/driving force F is larger than the first set braking/driving force F₁, the large braking/driving force flag FL is set to “1” at S58, and the value of the steering-angle-ratio change speed ΔR is made equal to “0” at S59. That is, the steering angle ratio R is prohibited from being changed, in other words, the steering angle ratio R is fixed to a value at the present time point.

When it is determined at S56 that the large braking/driving force flag FL is already set to “1”, S57 and S58 are skipped and the value of the steering-angle-ratio change speed ΔR is maintained at “0” at S59. When it is determined at S57 that the braking/driving force F is not larger than the first set braking/driving force F₁, the value of the steering-angle-ratio change speed ΔR determined at S54 is maintained.

At S60, it is determined whether the braking/driving force F is not larger than the second set braking/driving force F₂ that is set as a value smaller than the first set braking/driving force F₁. When the braking/driving force F is not larger than the second set braking/driving force F₂, the large braking/driving force flag FL is reset to “0” at S61. At S62, it is determined whether the absolute value of the steering-angle-ratio change speed ΔR is larger than the change-speed limit value ΔR_{LIM}. When the absolute value of the steering-angle-ratio change speed ΔR is larger than the change-speed limit value ΔR_{LIM}, it is determined at S63 whether the vehicle is in a braking state or in a driving (accelerating) state based on the braking/driving force F. When the vehicle is in the driving state, the steering-angle-ratio change speed ΔR is limited to the change-speed limit value ΔR_{LIM} at S64. When the vehicle is in the braking state, the steering-angle-ratio change speed ΔR is limited at S65 to the sign-inverted change-speed limit value ΔR_{LIM}, i.e., −ΔR_{LIM}. When the absolute value of the steering-angle-ratio change speed ΔR is not larger than the change-speed limit value ΔR_{LIM}, the steering-angle-ratio change speed ΔR is not limited. When it is determined at S60 that the braking/driving force F is larger than the second set braking/driving force F₂, the value of the steering-angle-ratio change speed ΔR is maintained at “0” in a case where the value of the large braking/driving force flag FL is “1”. On the other hand, the value of the steering-angle-ratio change speed ΔR determined at S54 is maintained in a case where the value of the large braking/driving force flag FL is “0”.

At S66, the steering angle ratio R is determined by adding the steering-angle-ratio change speed ΔR determined as described above to the previous steering angle ratio R_{PRE}. At S67, the determined steering angle ratio R is set as the previous steering angle ratio R_{PRE} to be used in next execution of the program.

What is claimed is:

1. A steering system for a vehicle, comprising: a pair of wheel steering devices that respectively steer right and left wheels independently of each other; and a controller configured to control the pair of wheel steering devices,
wherein the controller is configured to change, based on a running speed of the vehicle, a steering amount ratio that is a ratio between a steering amount of the right wheel and a steering amount of the left wheel and to limit, based on a degree of change in the running speed of the vehicle, a change speed of the steering amount ratio at which the controller changes the steering amount ratio.

2. The steering system according to claim 1,
wherein the controller is configured to:
determine the steering amount of one of the right and left wheels based on a steering request and determine the steering amount of the other of the right and left wheels based on i) the determined steering amount of the one of the right and left wheels and ii) the steering amount ratio set based on the running speed of the vehicle; and
limit the change speed of the steering amount ratio so as to limit a change in the steering amount of the other of the right and left wheels with respect to the steering amount of the one of the right and left wheels based on the degree of change in the running speed of the vehicle.

3. The steering system according to claim 1, wherein the controller is configured to limit the change speed of the steering amount ratio based on longitudinal acceleration of the vehicle that indicates the degree of change in the running speed of the vehicle.

4. The steering system according to claim 1, wherein the controller is configured to limit the change speed of the steering amount ratio based on a braking/driving force applied to the vehicle, the braking/driving force indicating the degree of change in the running speed of the vehicle.

5. The steering system according to claim 1, wherein the controller is configured to limit the change speed of the steering amount ratio to a higher extent when the degree of change in the running speed of the vehicle is high than when the degree of change in the running speed of the vehicle is low.

6. The steering system according to claim 1, wherein the controller fixes the steering amount ratio when the degree of change in the running speed of the vehicle exceeds a set first degree and allows the steering amount ratio to be changed at a speed not higher than a set change speed subsequently when the degree of change in the running speed of the vehicle becomes lower than or equal to a second degree that is set so as to be lower than the first degree.

7. The steering system according to claim 1, wherein the steering amount ratio is set such that a difference between the steering amount of the right wheel and the steering amount of the left wheel decreases with an increase in the running speed of the vehicle.

8. The steering system according to claim 1, wherein the steering amount ratio is a ratio according to an Ackermann ratio.

9. The steering system according to claim 1, wherein the steering amount ratio is determined such that the steering amount of a turning outer wheel that is one of the right and left wheels located closer to a center of turning of the vehicle is not larger than the steering amount of a turning inner wheel that is one of the right and left wheels located more distant from the center of turning of the vehicle.
